(19) United States
(12) Patent Application Publication
(10) Pub. No.: US 2005/0179542 A1
(43) Pub. Date: Aug. 18, 2005

(54) Acoustically activated key fob and method

(76) Inventor: William B. Young, Grand Rapids, MI (US)

Correspondence Address: WILLIAM B. YOUNG, 2509 VISTA POINT COURT NW, GRAND RAPIDS, MI, 49544, US

(21) Appl. No.: 10/777,593

(22) Filed: Feb. 13, 2004

(51) Int. Cl. G08B 1/08

(52) U.S. Cl. 340/539.32; 340/531; 340/426.13; 367/178

(57) ABSTRACT

A small hand held device that is activated thru a microphone by an acoustic signature. The acoustic signature activates programmed functions of the fob such as issuing the command to unlock a vehicle door.

### BACKGROUND OF THE INVENTION

Key fobs are commonplace in the automotive industry. They are small hand held devices that send commands, from remote distances, to automobiles. The commands sent to the automobile do such things as lock or unlock doors, open trunks or start the vehicle's engine. Present day key fobs are activated through the depression of mechanical switches. The present invention adds the ability for these key functions to be activated through an acoustic signature such as clapping of one's hands, uttering the voice command or tapping on a the window of a vehicle.

Key fobs that are presently used can only be operated when they are in physical contact with user. Therefore, if the key fob were to be accidentally locked within a vehicle and the owner/operator of the vehicle were to be on the outside of the vehicle, the key fob could do be used to command the vehicle to unlock its doors. If in the above scenario, an acoustically activated key fob were to be locked in the vehicle, the owner/operator of the vehicle could activate key fob commands by such things as tapping on the vehicle's window or uttering a voice command.

### SUMMARY OF THE INVENTION

According to a first aspect of the present invention, there is provided a key fob, with an internal microphone, which can be activated by an acoustical signature.

### BRIEF DESCRIPTION OF DRAWINGS

Preferred embodiments of the invention are explained below with reference to the accompanying drawings in which:

FIG. 1 shows a top view of an acoustically activated key fob according to a first embodiment of the present invention.

FIG. 2 shows a top view of an acoustically activated key fob according to a first embodiment of the present invention with its top cover removed to highlight the system's acoustic receiver (a microphone).

### DESCRIPTION OF THE PREFERRED EMBODIMENTS

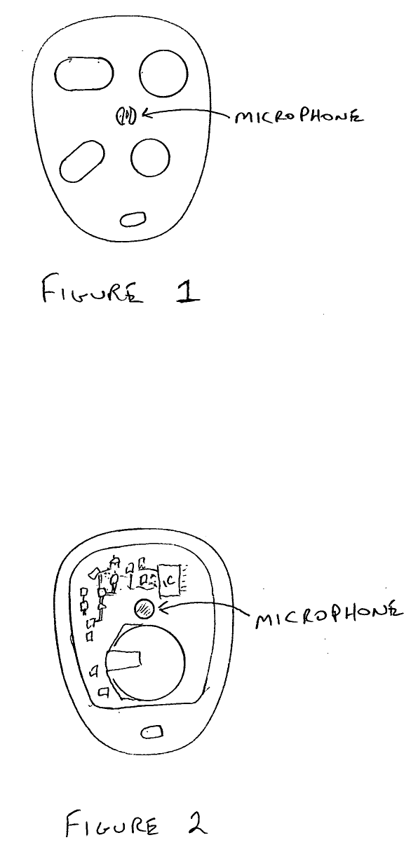

Referring to FIG. 1, there is depicted a top view of an acoustically activated key fob 1 according to a first embodiment of the present invention. Referring to FIG. 2, there is depicted a top view of an acoustically activated key fob according to a first embodiment of the present invention with its top cover removed to highlight the system's acoustic receiver 2(a microphone).

1. A key fob that is activated by an acoustic signature.
